(19) United States
(12) Patent Application Publication
(10) Pub. No.: US 2012/0048117 A1
(43) Pub. Date: Mar. 1, 2012

(54) SYSTEM FOR COLLECTING CONDENSED DEW WATER AND A METHOD OF USING THE SAME

(75) Inventors: Haim Katzir, Ashkelon (IL); Patrizia Katzir, Ashkelon (IL)

(73) Assignees: Patrizia Katzir, Ashkelon (IL); Haim Katzir, Ashkelon (IL)

(21) Appl. No.: 13/145,374

(22) PCT Filed: Jan. 21, 2010
(86) PCT No.: PCT/IL10/00053

§ 371 Date: Nov. 7, 2011

Related U.S. Application Data
(60) Provisional application No. 61/146,009, filed on Jan. 21, 2009.

(51) Int. Cl. B01D 5/00

(52) U.S. Cl. 95/289; 96/221

(57) ABSTRACT

A system for condensing water from atmospheric air is disclosed. The aforesaid device comprises (a) a structure comprising at least one cooled member connectable to a cooling device, the surface has a temperature lower than a dew point of an ambient atmosphere and adapted to condense water from ambient atmosphere; (b) at least one water collecting channel adapted to collect said water condensed on the cooled member and, (c) a water storage subsystem fluidly connected to at least one water collecting channel; The member is configured in a form of a hollow shell. The cooled member has an outer downward surface.

### FIELD OF THE INVENTION

The present invention generally relates to condensing dew and collecting the condensed water. The present invention particularly relates to a system and method of condensing a substantial portion of dew water molecules, accumulating and storing the water for local use.

### BACKGROUND OF THE INVENTION

A desert is a hostile, potentially deadly environment for unprepared humans. In hot deserts, high temperatures cause rapid loss of water due to sweating, and the absence of water sources with which to replenish it can result in dehydration and death within a few days. Shortage in the supply of potable water and freshwater is increasing at a vast rate, as deserts expand and overtake fertile land and as many of the natural ground water-resources are being depleted. Shifts in the patterns of the global climate throughout time have resulted in a drop in the rate of rainfall in many areas. Hunger and starvation is spreading in Africa because of the shortage of freshwater required to raise domestic animals and produce crops for food.

Sparse population and scattered population pockets in many areas make the application of water desalination and treatment technologies uneconomical due to the low demand and the high cost of water distribution from a central system over a wide stretch of land. Transportation of loads of freshwater is costly and exposes water to contamination en route and during handling and storage.

Accordingly, there is a need for localized production of fresh water to provide water for human drinking and freshwater for raising animals and for irrigation as well as other human uses.

Atmospheric moisture is an excellent natural source of water regardless of the amount of water vapour content of the air. The lower layer of the atmosphere surrounding the earth contains over 3·10¹² m³ of renewable water, which is about 0.1% of the water stored on the surface of the earth. In comparison, the daily drinking water consumption of the earth population is about 2.12·10 m³, which is a very modest portion of the water entrapped in the atmosphere. That is, free atmospheric water accessible to all mankind on the earth can satisfy all drinking water needs anywhere and anytime with a lot to spare for irrigation and raising farm animals. The atmospheric moisture reserve will not be depleted by excessive extraction of water since the water vapour is continuously replenished by evaporation of surface water and the surface of the mountains and valleys due to the flow of hot air.

Accordingly, there is a need for systems to harvest moisture entrapped in ambient air for the provision of potable water for human and freshwater for agricultural uses including rearing of animal farms for food.

Additionally, many resorts and vacationing places are located in hot regions deprived from drinking water and freshwater since they are on spreads of arid lands by shorelines wherein groundwater is brackish and rainfall is rare. In spite of the popularity of those areas, construction of desalination plants to produce freshwater for tourists is not economically viable due to the briefness of the tourism seasons and decline of demand most of the year. Reliance on bottled water is expensive for the average consumer while this source will not provide freshwater for other uses.

Accordingly, there is a need for systems for local water production from atmospheric humidity to supply fresh water to cabins, camping areas and tourist areas during tourism seasons in regions characterized by hot weather throughout the busy seasons. Systems compatible with tourist regions should reduce expenditure on drinking water and provide excess water for other human uses as long as the weather conditions are appropriate.

U.S. Pat. No. 6,868,690 discloses systems and methods for extracting freshwater from atmospheric humidity in extremely hot and humid climates and supplying freshwater to a small group of people, a building, a farm, or forestation area. Compact units provide drinking water for individuals, passengers in cars, vans, trucks, or recreational boats, or crewmembers on a seagoing cargo ship whether from atmospheric humidity or from moisture-laden gases. Furthermore, systems are disclosed for supplying freshwater with minimal treatment for small- to large-sized buildings in a manner that alleviates the heat load on buildings. Collection of freshwater from hot humid ambient air is also provided for other uses, such as irrigation and farm animal drinking. Various methods are used for condensation of water vapour suspended in the air as an alternative to conventional refrigeration cycles using CFC refrigerants. Devices are disclosed using naturally occurring brackish cold water, circulation of cooling water cooled by thermoelectric cooling or thermoacoustic refrigeration as well as evaporative cooling and transpiration cooling.

It is appreciated that water vapour is condensed on a cold surface and gravitationally slips from the aforesaid surface. This occurs when a droplet held on the surface by the surface tension force achieves a size large enough such that the force of gravity detaches the condensed droplet and it slips downwards. In the light of the described mechanism of collecting the condensed water, intensification of the condensation process can be attained by means of artificial agglomeration of the condensed droplets and forcing the agglomerated droplets to slip down. Thus, there is an unmet and long-felt need to provide effective means and method that facilitates the condensed droplet agglomeration and slipping of the aforesaid droplets to the collecting means.

### SUMMARY OF THE INVENTION

It is hence one object of the invention to disclose a system for condensing water from atmospheric air. The aforesaid device comprises (a) a structure comprising at least one cooled member connectable to a cooling device, said surface has a temperature lower than a dew point of an ambient atmosphere and adapted to condense water from ambient atmosphere; (b) at least one water collecting channel adapted to collect said water condensed on said cooled member and (c) a water storage subsystem fluidly connected to said at least one water collecting channel;

It is a core purpose of the invention to provide the member configured in a form of a hollow shell and wherein said member has an outer downward.

Another object of the invention is to disclose the shell configured in a form of an oblique triangle prism, a bisector of an oblique angle of said prism is sufficiently in parallel to a direction of gravity.

A further object of the invention is to disclose the shell which is in a fluidly interconnection with said cooling device: a cooling fluid is fed into a upper portion of said hollow shell and evacuated out of a bottom portion of said hollow shell.

A further object of the invention is to disclose the system further comprising means adapted to assist collecting water droplets. The aforesaid means is adapted to assist mergence of smaller droplets by greater droplets, surmounting a force of surface tension and thus causing the droplets to slip into the collecting channels.

A further object of the invention is to disclose the assisting means further comprising a spray device adapted to provide the slanted surface with droplets of a size sufficient for surmounting a force of surface tension and causing the droplets to slip into the collecting channels.

A further object of the invention is to disclose the assisting means further comprising a device adapted for mechanically moving the condensed droplets to the collecting channel. A further object of the invention is to disclose the mechanical means selected from the group consisting of a clapping system, drumming system, vibrating system and any combination thereof.

A further object of the invention is to disclose the device further comprising an elongate member slidably contacted with the member surface and adapted for reciprocatively moving so that the condensed droplets are propelled into the collecting channels.

A further object of the invention is to disclose the cooled member having an internal cavity and inlet and outlet openings fluidly connectable to the cooling device. The device provides the cooled member with a coolant flow in a closed-cycle manner.

A further object of the invention is to disclose the cooled member made of a material selected from the group consisting of plastic, metal, glass, ceramics and any combination thereof.

A further object of the invention is to disclose the cooling device adapted to provide a cooled air flow in a closed-cycle manner.

A further object of the invention is to disclose the assisting means activated in accordance with a predetermined temporal protocol.

A further object of the invention is to disclose the spray device fed with water from the water storage subsystem.

A further object of the invention is to disclose the cooled member configured in a form of a two-walled plate vertically oriented relative to the earth's surface and blown therethrough by means of the cooled air.

A further object of the invention is to disclose the cooled member is double walled. The cooled member is angularly oriented relative to the earth surface and blown therethrough by means of the cooled air.

A further object of the invention is to disclose the cooled member configured in a form selected from the group consisting of a double wall sleeve, a double wall panel, a double wall roof, double wall housing, and any combination thereof.

A further object of the invention is to disclose the cooled member tilted to the Earth's surface at an angle ranged between 0 and 90 degrees.

A further object of the invention is to disclose the cooled member configured in a form of a two-walled greenhouse roof blown therethrough by means of the cooled air.

A further object of the invention is to disclose the greenhouse roof that is two-layered.

A further object of the invention is to disclose the cooled member covered with a water repelling material.

A further object of the invention is to disclose a method of condensing water from atmospheric air. The aforesaid method comprises the steps of: (a) providing a system for condensing water from atmospheric air further comprising: (i) a structure comprising at least one cooled member connectable to a cooling device; the member has an outer downward surface; (ii) at least one water droplet collecting and directing channel and pipe; and (iii) a water storage subsystem; (b) cooling the cooled member up to a temperature lower than the dew point of the ambient atmosphere; and (c) collecting condensed water droplets.

It is a core purpose of the invention to provide the step of collecting condensed water further comprises assisting said collecting condensed water by means of mergence of smaller droplets by greater droplets, surmounting a force of surface tension and causing water droplets to slip into the collecting channels.

A further object of the invention is to disclose the step of assisting, further comprising spraying and/or dripping the surface with droplets of a size sufficient for surmounting a force of surface tension and causing the droplets to slip into the collecting channels.

A further object of the invention is to disclose the step of assisting, further comprising mechanically moving the condensed droplets to the collecting channel.

A further object of the invention is to disclose the step of assisting, further comprising reciprocatively moving an elongate member slidably contacted with the member surface so that the condensed droplets are propelled into the collecting channels.

A further object of the invention is to disclose the step of cooling the cooled member, further comprising flowing a coolant in a closed-cycle manner.

A further object of the invention is to disclose the above system, wherein the cooled member made of a material selected from the group consisting of plastic, metal, glass, ceramics and any combination thereof.

A further object of the invention is to disclose the step of cooling, comprising a sub-step of flowing a cooled air in a closed-cycle manner.

A further object of the invention is to disclose the step of assisting, wherein assisting is performed in accordance with a predetermined temporal protocol.

A further object of the invention is to disclose the spraying/dripping device, wherein the spraying/dripping device is fed with water from the water storage subsystem.

A further object of the invention is to disclose a cooled member configured in a form of a two-walled plate vertically oriented relative to an earth surface and blown therethrough by means of the cooled air.

A further object of the invention is to disclose a cooled member configured in a form of the two-walled plate angularly oriented relative to the earth surface and blown therethrough by means of the cooled air.

A further object of the invention is to disclose a cooled member configured in a form of a two-walled greenhouse roof blown through therethrough by means of the cooled air.

A further object of the invention is to disclose the system for condensing water from atmospheric air combined with a solar energy collecting system and energized thereby.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which:

FIG. 1 is a schematic view of a system for condensing water from the atmospheric air;

FIG. 2 is a schematic view of a cooled member of the system of FIG. 1;

FIG. 3 is a schematic view of the cooled member, provided with a spraying device;

FIG. 4 is a schematic view of the cooled member, provided with a sliding bar;

FIG. 5 is a schematic view of a system for condensing water configured for a greenhouse application;

FIG. 6 is a schematic view of the tent-like system for condensing water;

FIG. 7 is a schematic view of the archy system for condensing water; and

FIG. 8 is a schematic view of the triangular system for condensing water.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a system for condensing water from atmospheric air and a method of using thereof.

The term ‘condensation’ hereinafter refers to change of the physical state of matter from gaseous phase into liquid phase. Water vapor that naturally condenses on cold surfaces into liquid water is called dew. Water vapor will only condense onto a surface when the temperature of the aforesaid surface is cooler than the dew point temperature of the water vapor. The dew point temperature is defined as the temperature to which the air would have to cool (at constant pressure and constant water vapour content) in order to reach saturation. A state of saturation exists when the air is holding the maximum amount of water vapour possible at the existing temperature and pressure. Condensation of water vapour begins when the temperature of air is lowered to its dew point and beyond.

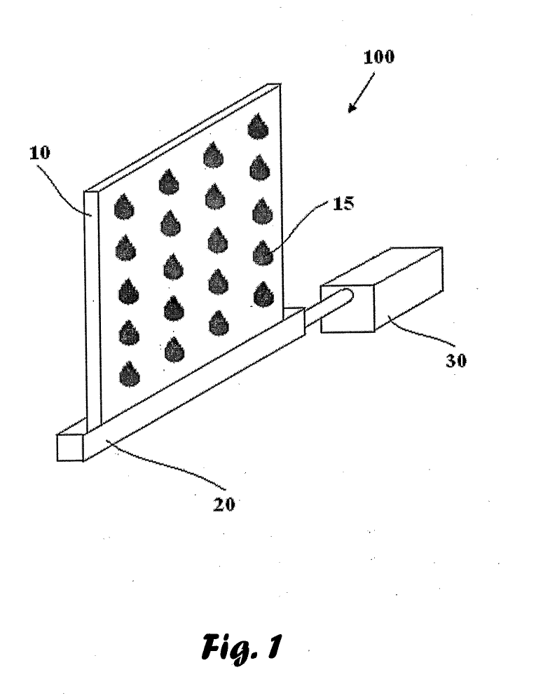

Reference is now made to FIG. 1, a system 100 for condensing water from atmospheric air. A cooled member 10 is at a temperature, lower than the dew point of the ambient atmosphere. The member 10 is cooled by standard cooling means in a closed-cycle manner (not shown). Droplets 15 schematically symbolize water droplets condensed on a surface of the member 10. The smaller condensed droplets 15 are agglomerated into the greater droplets. When the force of gravity is able to detach the agglomerated droplet held on the member surface by the force of surface tension, the aforesaid droplet will slip downwards into a water collecting channel 20. The collecting channel is fluidly connected to a water storage tank 30. Thus, the cooled member 10 is vertically or obliquely oriented relative the surface of the Earth so that the droplets 15 slip into the collecting channel 20 and further run to the tank 30.

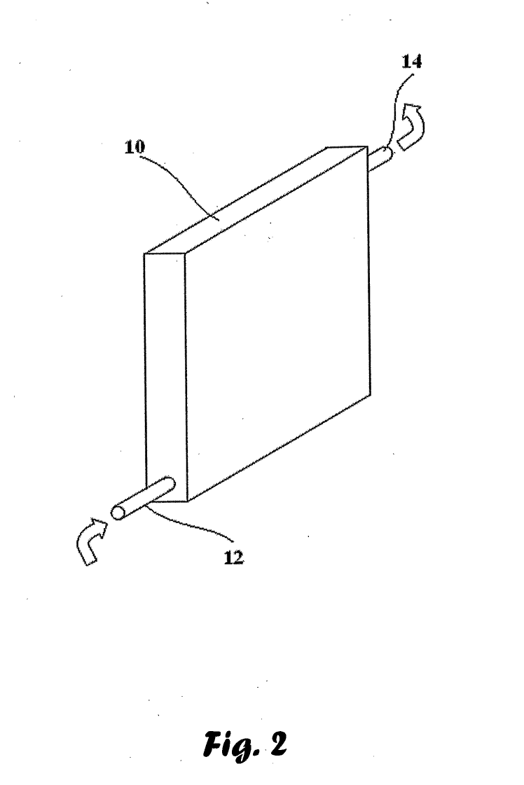

Reference is now made to FIG. 2, showing the cooled member 10 provided with a feed pipe 12 and exhausting pipe 14. In accordance with the current invention, any configurations of the cooled member and the pipes 12 and 14 are in the scope the current invention. Arrows indicate the flow directions of cooled air used as a coolant. Any other coolants reside in the scope of the current invention. The coolant is provided to the feed pipe 12 and drained from the exhaust pipe 14. The coolant is pumped through the member 10 by the standard cooling machine in a closed-cycle manner.

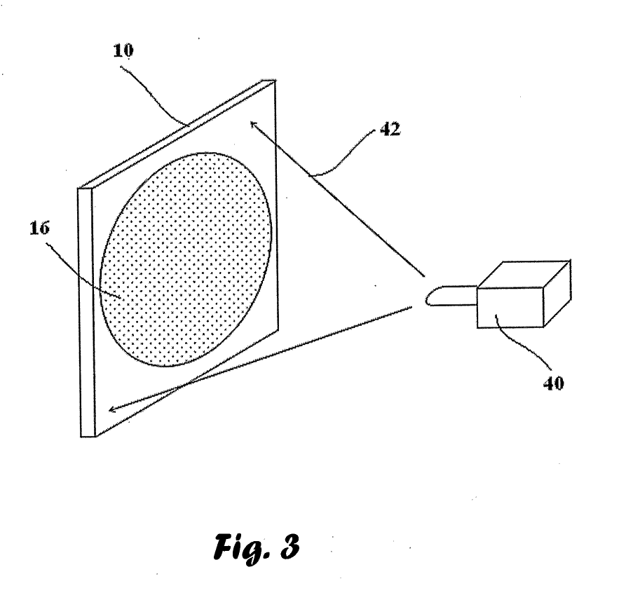

Reference is now made to FIG. 3, presenting the cooled member 10 provided with a spraying/dripping device 40. The aforesaid device 40 is adapted to atomize the water fed from the tank 30. Physical meaning of spraying and/or dripping the water in a direction of the cooled member 20 is in assisting agglomeration of the condensed droplets and quicker slipping the agglomerated droplets to the collecting channel (not shown). The diverging flow of sprayed droplets is graphically defined by arrows 42. The sprayed droplets reach the surface area 16 and assist slipping of the condensed droplets 15 (not shown) by means of quicker agglomeration of the smaller droplets into greater ones so that the gravity force achieved is sufficient for detaching the aforesaid droplets held on the member surface by the surface tension force. The agglomerated droplets having a sufficient mass slip into the collecting channel 20 (not shown).

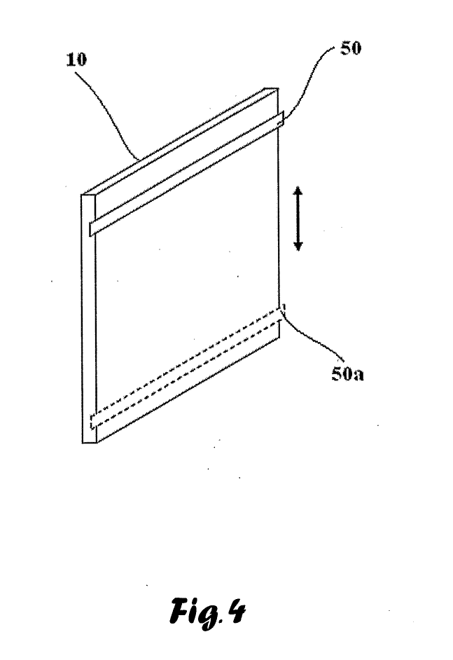

Reference is now made to FIG. 4, showing the cooled member 10 provided with a slidably attached bar. The attached bar is adapted to reciprocatively move (back and forth between at least two positions) along the cooled member 10. Numerals 50 and 50a indicate two uppermost and lowermost positions of the bar. When positioned in the position 50, the bar is in a standby position. In accordance with a predetermined protocol, the bar moves from the position 50 to the position 50a and back. Intervals between bar travels are defined by intensity of water condensation. The condensed droplets are thus assisted to slip into the collecting channel 20 (not shown).

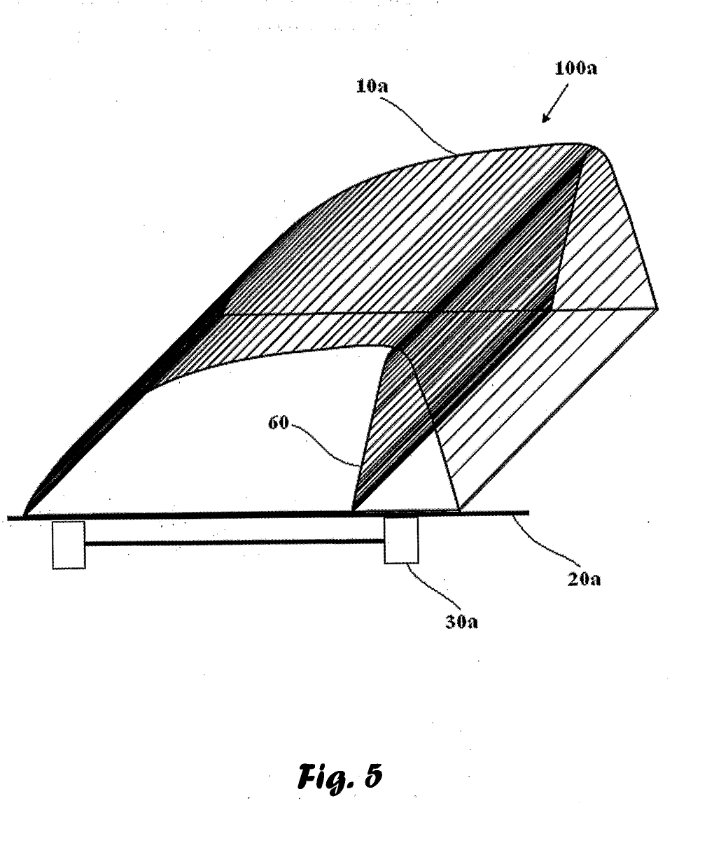

Reference is now made to FIG. 5, presenting an embodiment of the present invention which encompasses the water generating surface with the agricultural area. System 100a is combined from a dedicated water generating device 100a and a greenhouse 60. The shape of the greenhouse cover is adaptable to generating flowing water. In accordance with one of the embodiments of the current invention, greenhouse is covered with a water repelling material. Hence the greenhouse cover is also used as a water generating device. Water from member 10a and water from the green house 60 is flowing into storage tank into the collecting channel 20a and further into the storage tank 30a.

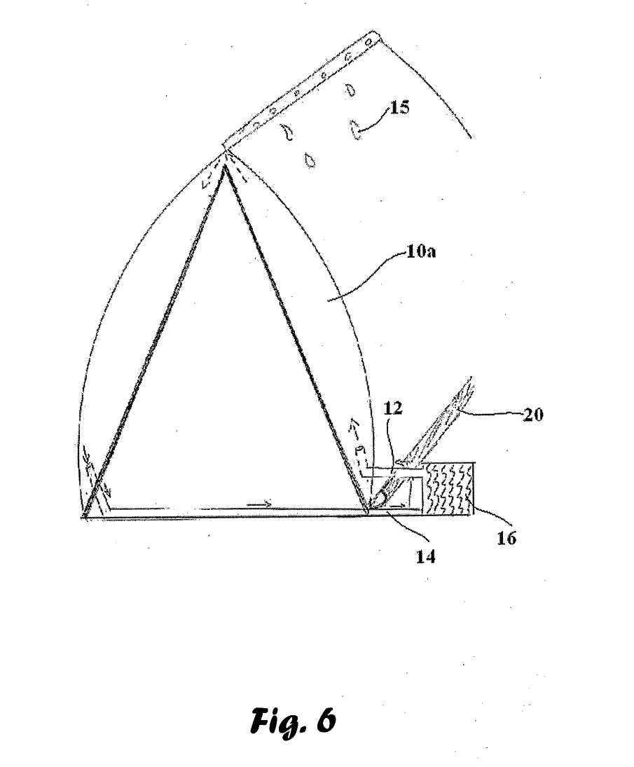

Reference is made to FIG. 6, presenting a greenhouse of triangle cross section. Hollow members 10a are cooled by a flow of cold air. A cooling machine 16 makes the air flow circulate through the aforesaid hollow members 10a. The cold air is fed through a pipe 12 and returns through a pipe 14. Condensed water is collected in a channel 20.

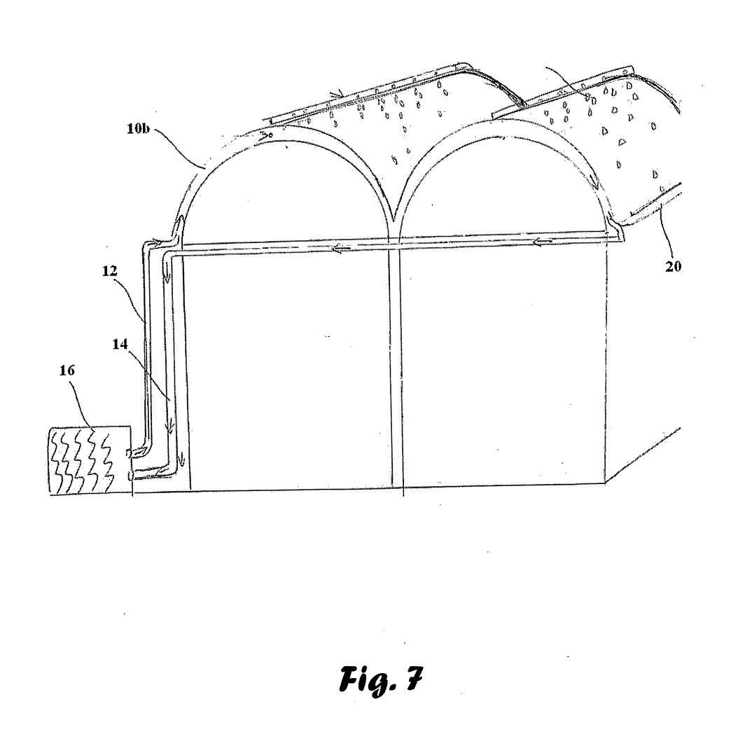

Reference is made to FIG. 7, showing an alternative embodiment of a greenhouse comprising an arched roof 10b. Analogously to the previous embodiment, the cooling machine 16 makes the air flow circulate through the aforesaid hollow members 10b. The cold air is fed through a pipe 12 and returns through a pipe 14. Condensed water is collected in a channel 20.

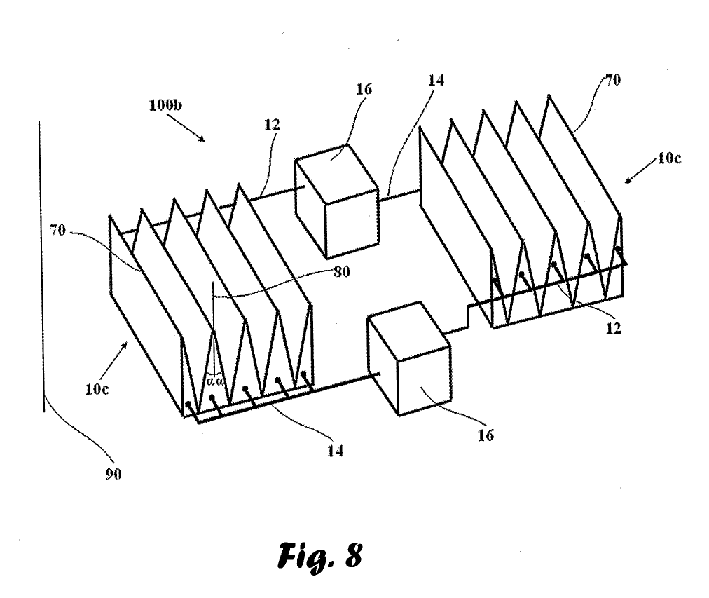

Reference is made to FIG. 8, presenting an alternative embodiment of the current invention. A system 100b is designed for condensing water from atmospheric air. The system 100b constitutes a cooling circuit of a closed type. Specifically, in a unlimited manner, the system 100b comprises cooling devices 16, cooled members 10c configured in a shape of plurality of oblique hollow triangle prisms 70. Bisectors 80 of oblique angles 2α of the prisms 70 are sufficiently in parallel to a direction of gravity 90 (vertical). The cooled members 10c and cooling devices 16 are interconnected by means of feed pipes 12 and exhaust pipes 14. It should be emphasized that the feed pipes 12 are fluidly connected to, upper portions of the prisms 70 while the exhaust pipes 16 are fluidly connected to bottom portions of the aforesaid prisms 70. The coolant provided by the cooling devices 16 is fed into the upper portions of the prisms 70. Further, within the prisms 70 the coolant naturally descends to the bottom portions of the prisms 70 and whereafter is evacuated from the bottom portions of the prisms 70. Closed-loop circuit of cooling provides minimal power consumption, because energy losses are kept as small as possible.

### EXAMPLE 1

Calculations are based on the data obtained from the experiments performed on a closed-loop cooled sleeve.

In accordance with one embodiment of the current invention, the cooled body (shell) comprises a number of sleeves or prisms arranged in parallel, each sleeve or prism has a triangular cross section. Specifically,in this example, the cooled body comprises 10 triangular sleeves (width 0.25 m, height 2 m, length 25M). The sleeves accommodate 62.5 m³ of air. It should be taken into account that at night the temperature of environmental air drops. The power needed for keeping the sleeve surfaces at the dew temperature within ±3° is equivalent to the electric motor power of a 20-ft conventional freezer. The power consumption of this motor is about 1 kW. The performed calculations provide the following system output: 1 m³ per 1 kWh.

In accordance with one embodiment of the current invention, a system for condensing water from atmospheric air is disclosed. The aforesaid device comprises (a) a structure comprising at least one cooled member connectable to a cooling device, said surface has a temperature lower than a dew point of an ambient atmosphere and adapted to condense water from ambient atmosphere; (b) at least one water collecting channel adapted to collect said water condensed on said cooled member and (c) a water storage subsystem fluidly connected to said at least one water collecting channel.

The core of the current invention is to provide the member configured in a form of a hollow shell. The cooled member has an outer downward surface.

In accordance with one embodiment of the current invention, the shell is configured in a form of an oblique triangle prism. A bisector of an oblique angle of said prism is sufficiently in parallel to a direction of gravity.

In accordance with one embodiment of the current invention, the shell is in a fluidly interconnection with said cooling device: a cooling fluid is fed into an upper portion of said hollow shell and evacuated out of a bottom portion of said hollow shell.

In accordance with one embodiment of the current invention, The core of the current invention is to provide the above system further including means adapted to assist collecting water droplets; the means is adapted to assist mergence of smaller droplets by greater droplets, surmounting a force of surface tension and causing the droplets to slip into the collecting channels.

In accordance with another embodiment of the current invention, the assisting means further comprises a spray device adapted to provide the slanted surface with droplets of a size sufficient for surmounting a force of surface tension and causing the droplets to slip into the collecting channels.

In accordance with a further embodiment of the current invention, the assisting means further comprises a device adapted for mechanically moving the condensed droplets to the collecting channel.

In accordance with a further embodiment of the current invention, the mechanical means is selected from the group consisting of a clapping system, drumming system, vibrating system and any combination thereof.

In accordance with a further embodiment of the current invention, the device further comprises an elongate member slidably contacted with the surface and adapted for reciprocatively moving so that the condensed droplets are propelled into the collecting channels.

In accordance with a further embodiment of the current invention, the cooled member has an internal cavity and inlet and outlet openings fluidly connectable to the cooling device. The cooling device provides the member with a coolant flow in a closed-cycle manner.

In accordance with a further embodiment of the current invention, the cooled member is made of a material selected from the group consisting of plastic, metal, glass, ceramics and any combination thereof. It is herein acknowledged that the term plastic also includes silicone, and silicone derived products, whether as discrete sheets, layers or as coatings. It is further herein acknowledged that the cooled member may comprise any thermo conductive material such as polymer or polymers, resins, naturally occuring or synthetic.

In accordance with a further embodiment of the current invention; the cooling device is adapted to provide a cooled air flow in a closed-cycle manner.

In accordance with a further embodiment of the current invention, the assisting means is activated in accordance with a predetermined temporal protocol.

In accordance with a further embodiment of the current invention, the spray device is fed with the water from the water storage subsystem.

In accordance with a further embodiment of the current invention, the cooled member is double-walled plate. The cooled member is vertically oriented relative to the earth's surface and blown therethrough by means of the cooled air.

In accordance with a further embodiment of the current invention, the cooled member configured in a form selected from the group consisting of a double wall sleeve, a double wall panel, a double wall roof, double wall housing, and any combination thereof.

In accordance with a further embodiment of the current invention, the cooled member tilted to the Earth's surface at an angle ranged between 0 and 90 degrees.

In accordance with a further embodiment of the current invention, the cooled member is configured in a form of the two-walled plate angularly oriented relative to the earth's surface and blown therethrough by means of the cooled air.

A further object of the invention is to disclose the greenhouse roof that is two-layered.

In accordance with a further embodiment of the current invention, the cooled member is configured in a form of a two-walled greenhouse roof blown therethrough by means of the cooled air.

In accordance with a further embodiment of the current invention, the cooled member covered with a water repelling material.

The present invention also relates to a method of condensing and collecting water from atmospheric air, the method comprising the steps of (a) providing a system for condensing water from atmospheric air, the system comprising (i) a structure comprising at least one cooled member connectable to a cooling device; the member has an outer downward surface; (ii) water collecting channel; and (iii) a water storage subsystem; (b) cooling the cooled member up to a temperature lower a dew point of an ambient atmosphere; (c) collecting the condensed water droplets:

The core of the current invention is to provide the step of collecting condensed water including a sub-step of assisting the collection of the condensed water by means of merging smaller droplets by greater droplets, surmounting a force of surface tension and causing the droplets to slip into the collecting channels.

In accordance with a further embodiment of the current invention, the step of assisting further comprises spraying and/or dripping the surface with droplets of a size sufficient for surmounting a force of surface tension and causing the droplets to slip into the collecting channels.

In accordance with a further embodiment of the current invention, the step of assisting further comprises mechanically moving the condensed droplets to the collecting channel.

In accordance with a further embodiment of the current invention, the step of assisting device further comprises reciprocatively moving an elongate member slidably contacted to the surface so that the condensed droplets are propelled off into the collecting channels.

In accordance with a further embodiment of the current invention, the step of cooling the cooled member further comprises flowing a coolant in a closed-cycle manner.

In accordance with a further embodiment of the current invention, the cooled member is made of a material selected from the group consisting of plastic, metal, glass, ceramics and any combination thereof.

In accordance with a further embodiment of the current invention, the step of cooling comprises a sub-step of flowing a cooled air in a closed-cycle manner.

In accordance with a further embodiment of the current invention, the step of assisting is performed in accordance with a predetermined temporal protocol.

In accordance with a further embodiment of the current invention, the spraying/dripping device is fed with water from the water storage subsystem.

In accordance with a further embodiment of the current invention, the cooled member is configured in a form of a two-walled plate vertically oriented relative to the earth's surface and blown therethrough by means of the cooled air.

In accordance with a further embodiment of the current invention, the step of providing the system further comprises providing the cooled member configured in a form of the two-walled plate angularly oriented relative to the earth's surface and blown therethrough by means of the cooled air.

In accordance with a further embodiment of the current invention, the cooled member is configured in a form of a two-walled greenhouse roof blown therethrough by means of the cooled air.

In accordance with a further embodiment of the current invention, the system for condensing water from atmospheric air is combined with a solar energy collecting system and energized thereby.

1-43. (canceled)

44. A system for condensing water from atmospheric air, comprising:
a. a structure comprising at least one cooled member connectable to a cooling device, said surface having a temperature lower than a dew point of an ambient atmosphere and adapted to condense water from ambient atmosphere;
b. at least one water collecting channel adapted to collect said water condensed on said cooled member and,
c. a water storage subsystem fluidly connected to said at least one water collecting channel;
wherein said member is configured in a form of a hollow shell and wherein said member has an outer downward surface and wherein said shell is configured in a form of an oblique triangle prism, a bisector of an oblique angle of said prism is substantially parallel to the direction of gravity.

45. The system according to claim 44, wherein said shell is in a fluid interconnection with said cooling device in a closed-loop manner: a cooling fluid is fed into an upper portion of said hollow shell and drained out of a bottom portion of said hollow shell.

46. The system according to claims 44, wherein power consumption of said system is less than about 1 kW per 1 m³.

47. The system according to claim 44, wherein said system further comprises assisting means to assist collecting water droplets, said assisting means being configured to assist mergence of smaller water droplets by greater water droplets, thereby surmounting the force of surface tension and causing condensed water droplets to slip from said surface into said at least one collecting channel.

48. The system according to claim 47, wherein said assisting means further comprises a spray device for providing said slanted surface with water droplets of a size sufficient for surmounting a force of surface tension and causing said droplets to slip into said at least one collecting channel.

49. The system according to claim 47, wherein said assisting means further comprises a device for mechanically moving said condensed droplets to said at least one collecting channel.

50. The system according to claim 49, wherein said mechanical means is selected from the group consisting of a clapping system, drumming system, vibrating system and any combination thereof.

51. The system according to claim 49, wherein said device comprises an elongate member slidably contacted to said surface and adapted for reciprocatively moving so that said condensed droplets are propelled off of said surface by said bar into said at least one collecting channel.

52. The system according to claim 44, wherein said cooled member has an internal cavity and inlet and outlet openings fluidly connectable to said cooling device; said cooling device for providing said cooled member with a coolant flow in a closed-cycle manner.

53. The system according to claim 44, wherein said cooled member is made of a material selected from the group consisting of plastic, metal, glass, ceramics and any combination thereof.

54. The system according to claim 52, wherein said cooling device is adapted to provide a cooled air flow in a closed-cycle manner.

55. The system according to claim 47, wherein said assisting means is activated in accordance with a predetermined temporal protocol.

56. The system according to claim 48, wherein said spray device is fed with water from said water storage subsystem.

57. The system according to claim 44, wherein said cooled member is configured in a form of a two-walled plate vertically oriented relative to the earth's surface and blown therethrough by means of said cooled air.

58. The system according to claim 44, wherein said cooled member is doublewalled;
said member is angularly oriented relative to the earth's surface and blown therethrough by means of said cooled air.

59. The system according to claim 44, wherein said cooled member is configured in a form selected from the group consisting of a double wall sleeve, a double wall panel, a double wall roof, double wall housing, and any combination thereof.

60. The system according to claim 44, wherein said cooled member is tilted to the Earth's surface at an angle ranged between 0 and 90 degrees.

61. The system according to claim 44, wherein said cooled member is configured in a form of a two-layered greenhouse roof blown therethrough by means of said cooled air.

62. The system according to claim 44, combined with a solar energy collecting system and energized thereby.

63. The system according to claim 44, wherein said cooled member is made of silicone, and silicone derived products, whether as discrete sheets, layers or as coatings.

64. The system according to claim 44, wherein said cooled member comprise any thermo conductive material such as polymer or polymers, resins, naturally occurring or synthetic.

65. The system according to claim 44, wherein said cooled member covered with a water repelling material.

66. A method of condensing and collecting water from atmospheric air, said method comprising the steps of:
a. providing a system for condensing water from atmospheric air further comprising:
i. a structure comprising at least one cooled member connectable to a cooling device, said surface has a temperature lower than a dew point of an ambient atmosphere and adapted to condense water from ambient atmosphere;
ii. at least one water collecting channel adapted to collect said water condensed on said cooled member and,
iii. a water storage subsystem fluidly connected to said at least one water collecting channel;
wherein said member is configured in a form of a hollow shell and wherein said member has an outer downward surface;
b. cooling said cooled member to a temperature lower than the dew point of an ambient atmosphere;
c. collecting condensed water droplets condensed on said surface into said water storage subsystem and wherein said provided shell is configured in a form of an oblique triangle prism, a bisector of an oblique angle of said prism is sufficiently in parallel to a direction of gravity.

67. The method according to claim 66, wherein said provided shell is in a fluidly interconnection with said cooling device: a cooling fluid is fed into a upper portion of said hollow shell and evacuated out of a bottom portion of said hollow shell.

68. The method according to claims 66, wherein power consumption of said system is less than about 1 kW per 1 m³.

69. The method according to claim 66, wherein said step of collecting condensed water droplets further comprises assisting said collecting condensed water by means of merging smaller droplets by greater droplets, thereby surmounting a force of surface tension and causing said droplets to slip into said at least one collecting channel.

70. The method according to claim 69, wherein said step of assisting comprises spraying and/or dripping said surface with droplets of a size sufficient for surmounting a force of surface tension and causing said droplets to slip into said at least one collecting channel.

71. The method according to claim 66, wherein said step of assisting comprises mechanically moving condensed droplets to said at least one collecting channel.

72. The method according to claim 71, wherein said mechanical means is selected from the group consisting of a clapping system, drumming system, vibrating system and any combination thereof.

73. The method according to claim 69, wherein said step of assisting further comprises reciprocatively moving an elongate member slidably contacted to said surface such that said condensed droplets are propelled off of said surface into said at least one collecting channel.

74. The method according to claim 66, wherein said step of cooling said cooled member comprises flowing a coolant in a closed-cycle manner.

75. The method according to claim 66, wherein said cooled member is made of a material selected from the group consisting of plastic, metal, glass, ceramics and any combination thereof.

76. The method according to claim 66, wherein said step of cooling comprises a sub-step of flowing a cooled air in a closed-cycle manner.

77. The method according to claim 66, wherein said step of assisting is performed in accordance with a predetermined temporal protocol.

78. The method according to claim 66, wherein said spraying/dripping device is fed with water from said water storage subsystem.

79. The method according to claim 66, wherein said cooled member is configured in a form of a two-walled plate vertically oriented relative to the earth's surface and blown therethrough by means of said cooled air.

80. The method according to claim 66, wherein said cooled member is configured in a form of said two-walled plate angularly oriented relative to the earth's surface and blown therethrough by means of said cooled air.

81. The method according to claim 66, wherein said cooled member is configured in a form selected from the group consisting of a double wall sleeve, a double wall panel, a double wall roof, double wall housing, and any combination thereof.

82. The method according to claim 66, wherein said cooled member is tilted to the Earth's surface at an angle ranged between 0 and 90 degrees.

83. The method according to claim 66, wherein said cooled member is configured in a form of a two-layered greenhouse roof blown therethrough by means of said cooled air.

84. The method according to claim 66, wherein said system is combined with a solar energy collecting system and energized thereby.
